(19) United States
(12) Patent Application Publication
(10) Pub. No.: US 2026/0005555 A1
(43) Pub. Date: Jan. 1, 2026

(54) ELECTRIC WORK MACHINE

(71) Applicant: MAKITA CORPORATION, Anjo-shi (JP)

(72) Inventors: Junya INUZUKA, Anjo-shi (JP); Fuminari Fujii, Anjo-shi (JP)

(73) Assignee: MAKITA CORPORATION, Anjo-shi (JP)

(21) Appl. No.: 19/253,041

(22) Filed: Jun. 27, 2025

(30) Foreign Application Priority Data
Jul. 1, 2024 (JP) 2024-106363

(51) Int. Cl. H02K 1/14; H02K 1/18; H02K 3/28; H02K 16/00

(52) U.S. Cl. CPC H02K 1/14; H02K 1/185; H02K 3/28; H02K 16/00

(57) ABSTRACT

An electric work machine in one aspect of the present disclosure corresponds to a first type of work machine. The first type of work machine includes a first brushless motor, a controller, and a first housing. The first brushless motor includes first coils and a first stator. The first stator has an inner shape and a first outer shape. A second type of work machine includes a second brushless motor and a second housing. The second brushless motor includes second coils and a second stator. The second stator has the inner shape common to that of the first brushless motor, and a second outer shape different from the first outer shape.

### CROSS-REFERENCE TO RELATED APPLICATIONS

The present application claims the benefit of Japanese Patent Application No. 2024-106363 filed on Jul. 1, 2024 with the Japan Patent Office, the entire disclosure of which is incorporated herein by reference.

### BACKGROUND

The present disclosure relates to a shape of a stator of a motor.

An electric power tool disclosed in Japanese Patent No. 5024609 includes a housing, a motor, and a fan. In the electric power tool, the motor is fixed to the housing by fitting protrusions in an outer periphery of the motor into recesses in the housing.

### SUMMARY

The electric work machine is an apparatus equipped with a motor, which includes an electric power tool. There are multiple types of electric work machines, and motor characteristics differ depending on the types. Motors with different characteristics have different motor-to-housing fixing means, different motor connections, different housing shapes, and so on. Accordingly, when multiple types of electric work machines are produced, production facilities increase or become complicated.

In one aspect of the present disclosure, it is desirable to provide a technique capable of simplifying production facilities that handle multiple types of electric work machines.

One aspect of the present disclosure provides an electric work machine corresponding to a first type of work machine in a work machine group that includes the first type of work machine and a second type of work machine. The first type of work machine includes a first brushless motor, a controller, and a first housing. The first brushless motor includes first coils, and a first stator. The first stator has an inner shape and a first outer shape. The inner shape has teeth and a specified inner diameter. Each of the teeth has a specified shape. The controller is configured to excite the first stator. The first housing is configured to house the first brushless motor. The second type of work machine includes a second brushless motor and a second housing. The second brushless motor includes second coils and a second stator. The second stator has the inner shape common to that of the first stator, and a second outer shape different from the first outer shape. The second housing is configured to house the second brushless motor.

The electric work machine in one aspect of the present disclosure corresponds to the first type of work machine, and the stator of the first type of work machine has the common inner shape with the stator of the second type of work machine. The common inner shape of the stators of the first and second types of work machines can simplify production facilities for multiple types of electric work machines.

Another aspect of the present disclosure provides an electric work machine corresponding to a first type of work machine in a work machine group that includes the first type of work machine and a second type of work machine. The first type of work machine includes a first brushless motor, a controller, and a first housing. The first brushless motor includes first coils and a first stator. The first coils are wound in parallel connection. The first stator has an inner shape and a first outer shape. The inner shape has teeth and a specified inner diameter. Each of the teeth has a specified shape. The controller is configured to excite the first stator. The first housing is configured to house the first brushless motor. The second type of work machine includes a second brushless motor and a second housing. The second brushless motor includes second coils and a second stator. The second coils are wound in series connection. The second stator has the inner shape common to that of the first stator The second housing is configured to house the second brushless motor.

The electric work machine in another aspect of the present disclosure corresponds to the first type of work machine, and the first type of work machine includes the parallel connection type motor. The second type of work machine includes the series connection type motor. The inner shape of the stator of the parallel connection type motor is common to the inner shape of the stator of the series connection type motor. The common inner shape of the stators of the parallel connection type and series connection type motors can simplify production facilities for multiple types of electric work machines.

Yet another aspect of the present disclosure provides an electric work machine including a first brushless motor, a controller, and a first housing. The first brushless motor includes first coils and a first stator. The first stator has an inner shape and an outer shape. The inner shape has teeth and a specified inner diameter. Each of the teeth has a specified shape. The inner shape is identical to an inner shape of a second stator of a second brushless motor included in another electric work machine. The outer shape differs from an outer shape of the second stator.

According to the electric work machine in yet another aspect of the present disclosure, the same effect as that of the electric work machine in one aspect of the present disclosure is achieved.

### BRIEF DESCRIPTION OF THE DRAWINGS

An example embodiment of the present disclosure will be described hereinafter by way of example with reference to the accompanying drawings, in which:

FIG. 1 shows an appearance of a first work machine of a first embodiment;

FIG. 2 shows a vertical cross-section of the first work machine of the first embodiment;

FIG. 3 shows a stator and a rotor of the first work machine of the first embodiment;

FIG. 4 shows the stator of the first work machine of the first embodiment being fixed to a housing;

FIG. 5 shows a stator core of the first work machine of the first embodiment;

FIG. 6 shows engagement of the stator core and the housing of the first work machine of the first embodiment;

FIG. 7 is a schematic diagram showing an enlarged engagement portion of the stator core and the housing of the first work machine of the first embodiment;

FIG. 8 shows a stator of a second work machine of the first embodiment being fixed to a housing;

FIG. 9 shows a stator core of the second work machine of the first embodiment;

FIG. 10 shows the housing of the second work machine of the first embodiment;

FIG. 11 shows engagement of the stator core and the housing of the second work machine of the first embodiment;

FIG. 12 is a schematic diagram showing an enlarged engagement portion of the stator core and the housing of the second work machine of the first embodiment;

FIG. 13 schematically shows coil connection of the first work machine of the first embodiment;

FIG. 14 schematically shows coil connection of the second work machine of the first embodiment;

FIG. 15 shows a stator of a first work machine of a second embodiment being fixed to a housing;

FIG. 16 shows the housing of the first work machine of the second embodiment;

FIG. 17 shows engagement of the stator core and the housing of the first work machine of the second embodiment;

FIG. 18 is a schematic diagram showing an enlarged engagement portion of the stator core and the housing of the first work machine of the second embodiment;

FIG. 19 shows a stator of a first work machine of a third embodiment being fixed to a housing;

FIG. 20A shows a stator of a first work machine of a fourth embodiment being fixed to a housing.

FIG. 20B shows the stator in FIG. 20A without a baffle;

FIG. 21 shows an insulator of a second work machine of a fifth embodiment being fixed to a housing;

FIG. 22 shows the insulator of the second work machine of the fifth embodiment;

FIG. 23 shows engagement of the insulator and the housing of the second work machine of the fifth embodiment; and

FIG. 24 is a schematic diagram showing an enlarged engagement portion of the insulator and the housing of the second work machine of the fifth embodiment.

### DETAILED DESCRIPTION OF EXEMPLARY EMBODIMENTS

### Overview of Embodiments

One embodiment may provide an electric work machine including at least any one of:
Feature 1: the electric work machine corresponds to a first type of work machine in a work machine group that includes the first type of work machine and a second type of work machine;
Feature 2: the first type of work machine includes a first brushless motor;
Feature 3: the first brushless motor includes first coils and a first stator;
Feature 4: the first stator has an inner shape and a first outer shape;
Feature 5: the inner shape has teeth and a specified inner diameter;
Feature 6: each of the teeth has a specified shape;
Feature 7: the first type of work machine includes a controller configured to excite the first stator;
Feature 8: the first type of work machine includes a first housing configured to house the first brushless motor;
Feature 9: the second type of work machine includes a second brushless motor;
Feature 10: the second brushless motor includes second coils and a second stator;
Feature 11: the second stator has the inner shape common to that of the first stator;
Feature 12: the second stator has a second outer shape different from the first outer shape; and
Feature 13: the second type of work machine includes a second housing configured to house the second brushless motor.

The electric work machine including at least Features 1 through 13 corresponds to the first type of work machine, and the stator of the first type of work machine has the common inner shape with the stator of the second type of work machine. The common inner shape to the stators of the first and second types of work machines can simplify production facilities for multiple types of electric work machines.

One embodiment may include, in addition to or in place of at least any one of Features 1 through 13, at least any one of:
Feature 14: the first housing has a first inner circumferential surface, and a first engagement portion arranged on the first inner circumferential surface;
Feature 15: the first outer shape has a first outer circumferential surface facing the first inner circumferential surface, and a second engagement portion arranged on the first outer circumferential surface and configured to engage the first engagement portion;
Feature 16: the second housing has a second inner circumferential surface, and a third engagement portion arranged on the second inner circumferential surface and different in shape from the first engagement portion; and
Feature 17: the second outer shape has a second outer circumferential surface facing the second inner circumferential surface, and a fourth engagement portion arranged on the second outer circumferential surface, different in shape from the second engagement portion, and configured to engage the third engagement portion.

The inner shape of the stator of the electric work machine including at least at least Features 1 through 17 can be common to an inner shape of a stator of another type of electric work machine with a different stator-to-housing fixing structure.

One embodiment may include, in addition to or in place of at least any one of Features 1 through 17:
Feature 18: the second engagement portion has a stator recess indented radially inward from the first outer circumferential surface; and
Feature 19: the fourth engagement portion has a stator protrusion projecting radially outward from the first outer circumferential surface.

The motor of the electric work machine including at least Features 1 through 19 is fixed to the housing by the stator recess, and can have the inner shape of the stator common to that of the motor fixed to the housing by the stator protrusion.

One embodiment may include, in addition to or in place of at least any one of Features 1 through 19,
Feature 20: The stator recess is located radially outward of at least one of the teeth.

The electric work machine including at least Features 1 through 20 can inhibit increase in magnetic resistance of the stator due to formation of a recess on an outer circumferential surface of the stator since the stator recess is located radially outward of the teeth.

One embodiment may include, in addition to or in place of at least any one of the above-described Features 1 through 20:
Feature 21: the first engagement portion has a housing protrusion projecting radially inward from the first inner circumferential surface;
Feature 22: the housing protrusion has a first plane, a second plane, and a first connecting portion between the first and second planes;
Feature 23: the first connecting portion projects radially inward from the first inner circumferential surface;
Feature 24: the stator recess has a third plane, a fourth plane, and a second connecting portion between the third and fourth planes;
Feature 25: the second connecting portion is indented radially inward from the first outer circumferential surface; and
Feature 26: in a state where the housing protrusion is engaged with the stator recess, the first plane is in contact with the third plane and the second plane is in contact with the fourth plane.

In the electric work machine including at least Features 1 through 19 and 21 through 26, a circumferential position of the stator relative to the housing can be firmly fixed by two faces of the stator recess engaging two faces of the housing protrusion.

One embodiment may include, in addition to or in place of at least any one of the above-described Features 1 through 26,
Feature 27: the first coils are wound around the teeth in parallel connection.

One embodiment may include, in addition to or in place of at least any one of the above-described Features 1 through 27:
Feature 28: the first stator includes a first fusing terminal and a second fusing terminal;
Feature 29: the first stator includes a short-circuit member;
Feature 30: the first coils include two first-phase coils corresponding to a first phase of the motor, and two second-phase coils corresponding to a second phase of the motor;
Feature 31: one of the two first-phase coils is disposed adjacent to one of the two second phase coils, and is connected to the one of the second phase coils via the first fusing terminal;
Feature 32: the other of the two first phase coils is disposed adjacent to the other of the two second phase coils, and is connected to the other of the second phase coils via the second fusing terminal;
Feature 33: the short-circuit member connects the first fusing terminal to the second fusing terminal.

In the electric work machine including at least Features 1 through 19 and 27 through 33, the two first phase coils can be easily connected in parallel and the two second phase coils can be easily connected by the first and second fusing terminals and the short-circuit member.

One embodiment may include, in addition to or in place of at least any one of the above-described Features 1 through 33:
Feature 34: the first stator includes a first stator core having the inner shape and the first outer shape; and
Feature 35: the second stator includes a second stator core having the inner shape and the second outer shape.

In the electric work machine and the second type of work machine including at least Features 1 through 13, 34 and 35, an axial height of the stator can be reduced since the engagement portion is located in the stator core. Further, since vibration caused by rotation of the motor is inhibited from being transmitted to the coils, coil break can be inhibited.

One embodiment may include, in addition to or in place of at least any one of the above-described Features 1 through 35:
Feature 36: the second engagement portion has a stator protrusion projecting radially outward from the first outer circumferential surface; and
Feature 37: the fourth engagement portion has a stator recess indented radially inward from the first outer circumferential surface.

The motor of the electric work machine including at least Features 1 through 17, 36 and 37 is fixed to the housing by the stator protrusion, and can have the inner shape of the stator common to that of the motor fixed to the housing by the stator recess.

One embodiment may provide an electric work machine including at least any one of:
Feature 38: the electric work machine corresponds to a first type of work machine in a work machine group that includes the first type of work machine and a second type of work machine;
Feature 39: the first type of work machine includes a first brushless motor;
Feature 40: the first brushless motor includes first coils and a first stator;
Feature 41: the first coils are wound in parallel connection;
Feature 42: the first stator has an inner shape and a first outer shape;
Feature 43: the inner shape has teeth and a specified inner diameter;
Feature 44: each of the teeth has a specified shape;
Feature 45: the first type of work machine includes a controller configured to excite the first stator;
Feature 46: the first type of work machine includes a first housing configured to house the first brushless motor;
Feature 47: the second type of work machine includes a second brushless motor;
Feature 48: the second brushless motor includes second coils and a second stator;
Feature 49: the second coils are wound in series connection;
Feature 50: the second stator has the inner shape common to that of the first stator; and
Feature 51: the second type of work machine includes a second housing configured to house the second brushless motor.

The electric work machine including at least Features 38 through 51 corresponds to the first type of work machine including the parallel connection type motor, and the second type of electric work machine includes the series connection type motor. The stator of the parallel connection type motor has the common inner shape with the stator of the series connection type motor. The common inner shape of the stators of the first and second types of work machines can simplify production facilities for multiple types of electric work machines.

One embodiment may include, in addition to or in place of at least any one of the above-described Feature 38 through 51,
Feature 52: the second stator has a second outer shape different from the first outer shape.

The electric work machine including at least Features 38 through 52 has the parallel connection type motor. The stator of the parallel connection type motor can have a different outer shape from that of the series connection type motor.

One embodiment may include, in addition to or in place of at least any one of the above-described Feature 38 through 52:
Feature 53: the first stator is fixed to the first housing in an axial direction of the first brushless motor by a screw;
Feature 54: the second stator is fixed to the second housing in an axial direction of the second brushless motor by the second housing without a screw.

In the electric work machine including at least Features 38 through 54, the stator can be fixed to the housing in the axial direction by the screw. In the second type of electric work machine, the stator can be fixed to the housing in the axial direction without a screw.

One embodiment may include, in addition to or in place of at least any one of the above-described Feature 38 through 54:
Feature 55: the first housing includes an integral cylinder; and
Feature 56: the second housing includes a pair of halves.

The housing of the electric work machine including at least Features 38 through 56 is an integral cylinder. In the electric work machine, a circumferential position of the stator relative to the housing can be fixed by the stator being inserted to the housing. Also, an axial position of the stator relative to the housing can be fixed by the screw. The housing of the second type of work machine is a pair of halves. In the second type of work machine, circumferential and axial position of the stator relative to the housing can be fixed by assembling the housing to the stator.

Examples of the above-described first and second types of work machines include various types of equipment configured for use in construction, manufacturing, gardening, civil engineering, and other work sites, specifically, power tools for stone processing, metal processing, and wood processing; power tools for gardening; power tools for work site environment; fan vests, fan jackets, hand-held push carts; power-assisted bicycles; and inflators. The first type of work machine may be a work machine used for the same purpose as the second type of work machine, or a work machine used for different purposes.

In one embodiment, a work machine set including the first type of work machine including Features 2 through 8 and the second type of work machine including Features 9 through 13 may be provided.

In one embodiment, an electric work machine including at least one of:
Feature 57: a first brushless motor including first coils and a first stator;
Feature 58: the first stator has an inner shape and an outer shape;
Feature 59: the inner shape has teeth and a specified inner diameter;
Feature 60: each of the teeth has a specified shape;
Feature 61: the inner shape is identical to an inner shape of a second stator of the second brushless motor included in another electric work machine;
Feature 62: the outer shape differs from an outer shape of the second stator;
Feature 63: a controller configured to excite the first stator; and
Feature 64: a first housing configured to house the first brushless motor.

The stator of the electric work machine including at least Features 57 through 64 has the inner shape common to the inner shape of the stator of another electric work machine. The common inner shape of the stators of multiple types of electric work machines can simplify production facilities for multiple types of electric work machines.

Examples of the above-described power tools include an electric chainsaw, an electric handheld saw, an electric blower, an electric hammer, an electric hammer drill, an electric drill, an electric screwdriver, an electric wrench, an electric impact driver, an electric impact wrench, an electric grinder, an electric circular saw, an electric reciprocating saw, an electric jigsaw, an electric cutter, an electric planer, an electric nailer (including a tacker), an electric hedge trimmer, an electric lawn mower, an electric grass trimmer, an electric bush cutter, an electric cleaner, an electric sprayer, an electric spreader, an electric dust collector, an electric trowell, an electric vibrator, an electric rammer, an electric compactor, an electric pump, an electric pile driver, an electric concrete saw, an electric screed, and an electric cut-off saw.

Examples of the above-described first and second types of work machines may be in the form of battery-powered equipment configured to be powered by a battery. Specifically, examples of the above-described electric work machine may have a built-in battery or may have a battery pack detachably attached. The battery pack houses the battery.

In one embodiment, the above-described Features 1 through 64 may be combined in any combination.

In one embodiment, any of the above-described Features 1 through 64 may be excluded.

### Specific Example Embodiments

Embodiments of the present disclosure will be described below with reference to the drawings.

### 1. First Embodiment

### 1-1. Overall Configuration

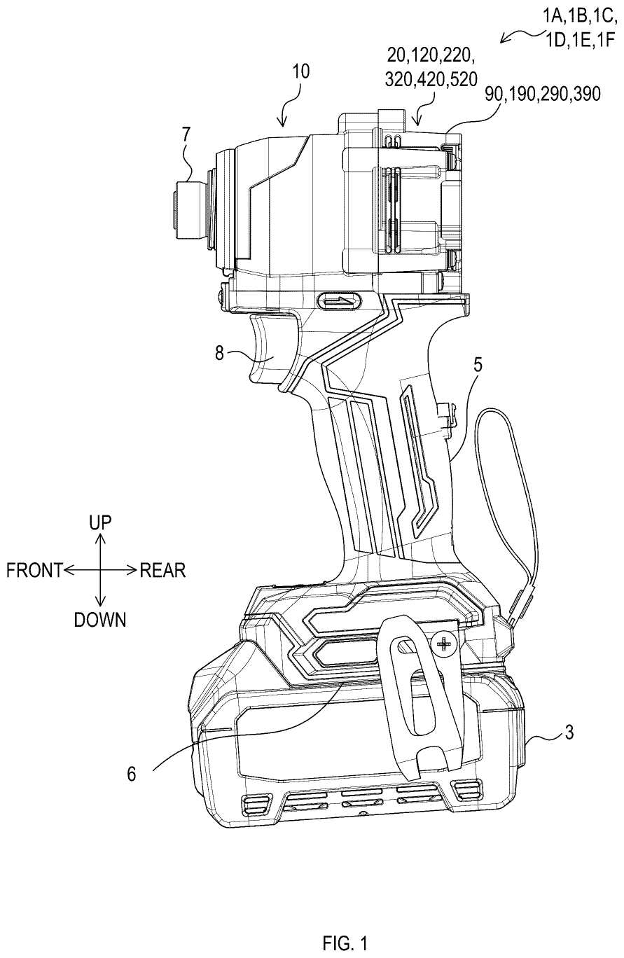

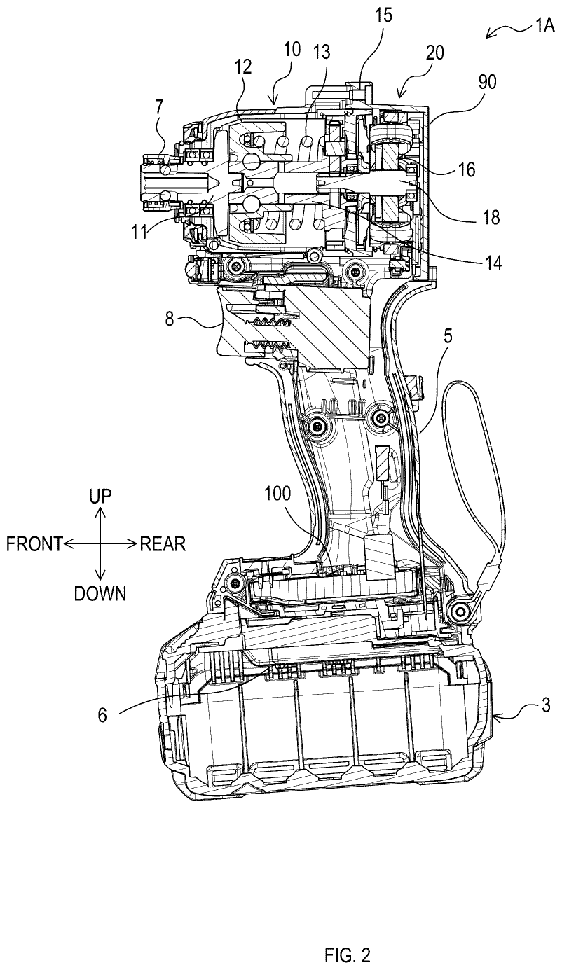

Referring to FIGS. 1 and 2, a work machine group of the present embodiment will be described. The work machine group includes multiple types of work machines manufactured by the same supplier. For example, the work machine group includes multiple types of work machines with a common logo associated with the manufacturer. In the present embodiment, the work machine group includes a convex motor electric work machine (hereinafter, referred to as “first type work machine”) 1A and a concave motor electric work machine (hereinafter, referred to as “second type work machine”) 1B. The first type work machine 1A and the second type work machine 1B of the present embodiment are impact drivers, a type of electric power tool.

First, a basic configuration of the first type work machine 1A will be described. The basic configuration of the first type work machine 1A is the same as that of the second type work machine 1B. The first type work machine 1A differs from the second type work machine 1B in that the first type work machine 1A includes a motor unit 20 while the second type work machine 1B includes a motor unit 120. Hereinafter, relative positions or directions are indicated with reference to a center of the first type work machine 1A.

The first type work machine 1A includes a head 10, the motor unit 20, a grip 5, a battery attachment portion 6, a chuck sleeve 7, and a trigger 8. The motor unit 20 is fixed to a rear end of the head 10 by a screw 15. The motor unit 20 includes a motor 25 and a housing 90 to be described later. The chuck sleeve 7 is attached to a front end of the head 10. Various types of tool bits are detachably attached to the chuck sleeve 7. The various types of tool bits include, for example, a driver bit and a socket bit. In another embodiment, at least one of the head 10, the grip 5, the battery attachment portion 6, the chuck sleeve 7, and the trigger 8 may be eliminated from the first type work machine 1A.

The grip 5 is provided at a lower end of the head 10 and the motor unit 20 and extends in an up-down direction. The grip 5 is held by a user of the first type work machine 1A. The battery attachment portion 6 is provided at a lower end of the grip 5. The battery pack 3 is detachably attached to the battery attachment portion 6. The battery pack 3 is, for example, a chargeable and dischargeable lithium-ion battery including multiple cells coupled in series.

The trigger 8 is provided on an upper front of the grip 5. The trigger 8 is manually operated by the user. Specifically, the motor 25 rotates when the user pulls the trigger 8, and the motor 25 stops when the user releases the trigger 8.

The head 10 includes therein a spindle 14, a coil spring 13, a hammer 12, and an anvil 11. The spindle 14 is coupled to a shaft 16 of the motor 25 via a planetary gear mechanism. The spindle 14 rotates as the motor 25 rotates. The hammer 12 is coupled to the spindle 14, and can integrally rotate with the spindle 14. The hammer 12 is movable along an axis of rotation of the spindle 14 (that is, in a front-rear direction). The hammer 12 is biased forward by the coil spring 13. The anvil 11 rotates by receiving a rotational force and/or a striking force from the hammer 12. The chuck sleeve 7 is attached to a front end of the anvil 11.

The hammer 12 integrally rotates with the spindle 14 in response to the motor 25 rotating the spindle 14. The rotational force of the hammer 12 is transmitted to the anvil 11 in response to rotation of the hammer 12. The chuck sleeve 7 integrally rotates with the anvil 11 in response to rotation of the anvil 11. This rotates a tool bit attached to the chuck sleeve 7.

The grip 5 includes a controller 100 inside a lower end thereof. The controller 100 is activated by receiving electric power from the battery pack 3, and controls various functions of the first type work machine 1A. For example, the controller 100 controls driving of the motor 25 by controlling a drive current supplied from the battery pack 3 to the motor 25.

### 1-2. Configuration of Motor

### 1-2-1. Motor with Cylindrical Housing, Convex Stator Core, and Series Connection

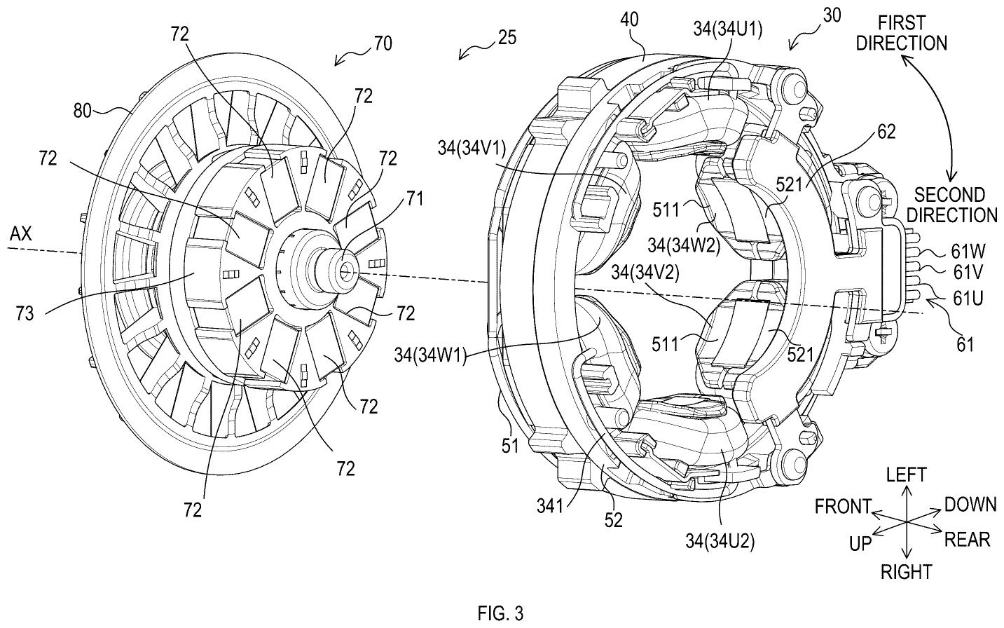

Next, referring to FIGS. 3 through 7, the motor unit 20 included in the first type work machine 1A will be described. The motor unit 20 includes a motor 25, a fan 80, a circuit board 62, and a housing 90. The motor 25 is an inner rotor motor including a rotor 70 and a stator 30. Also, in the present embodiment, the motor 25 is a three-phase brushless motor with eight poles and six slots. In another embodiment, the motor 25 may be a motor other than eight poles and six slots.

Hereinafter, a direction parallel to an axis of rotation AX of the motor 25 is referred to as “axial direction”, and a radial direction of the axis of rotation AX is referred to as “radial direction”. The axial direction coincides with the front-rear direction. A direction around the axis of rotation AX is referred to as “circumferential direction”. In the radial direction, a position close to or a direction approaching the axis of rotation AX is referred to as “radially inward”, and a position far from or a direction away from the axis of rotation AX is referred to as “radially outward”. Further, in the circumferential direction, a direction from top to right is referred to as “first direction” and a direction from top to left is referred to as “second direction”, in a state facing forward.

### 1-2-1a. Rotor

FIG. 3 is a perspective view of the rotor 70 and the stator 30 from a rear thereof. The rotor 70 includes a rotor core 73, a rotor shaft 71, and magnetic pole portions 72. The rotor 70 rotates about the axis of rotation AX.

The rotor core 73 includes laminated steel plates. The steel plates are metallic sheets made primarily of iron. The rotor core 73 is arranged to surround the axis of rotation AX. The rotor core 73 has an approximately cylindrical shape. The rotor core 73 has an opening, in its center, which passes through front and rear surfaces of the rotor core 73.

The rotor shaft 71 is arranged in the opening in the center of the rotor core 73, and extends in the axial direction. The rotor shaft 71 is fixed to the rotor core 73. A front part of the rotor shaft 71 protrudes forward from a front end of the rotor core 73, and is rotatably supported by a front bearing (not shown). A rear part of the rotor shaft 71 protrudes rearward from a rear end of the rotor core 73, and is rotatably supported by a rear bearing (not shown).

The magnetic pole portions 72 are arranged at regular intervals in the circumferential direction of the rotor core 73. Each of the magnetic pole portions 72 has a permanent magnet buried in the rotor core 73, and extends along the radial direction. Specifically, the magnetic pole portions 72 are arranged in a spoke-like configuration. Each of the magnetic pole portions 72 has a north pole region and a south pole region, and the magnetic pole portions 72 are arranged so that the same poles face each other along the circumferential direction. Specifically, a north pole of one magnetic pole portion 72 faces a north pole of the adjacent magnetic pole portion 72 in the circumferential direction. Also, a south pole of one magnetic pole portion 72 faces a south pole of the adjacent magnetic pole portion 72 in the circumferential direction. In the present embodiment, the magnetic pole portions 72 include eight magnetic pole portions 72.

The fan 80 is fixed to the front part of the rotor shaft 71. The fan 80 is located ahead of the rotor core 73. When the rotor shaft 71 rotates, the fan 80 rotates together with the rotor shaft 71.

### 1-2-1b. Stator

The stator 30 includes a stator core 40, a first insulator 51, a second insulator 52, coils 34, and a power supply line 61. The first insulator 51 and the second insulator 52 may be fixed to the stator core 40 by being integrally formed with the stator core 40.

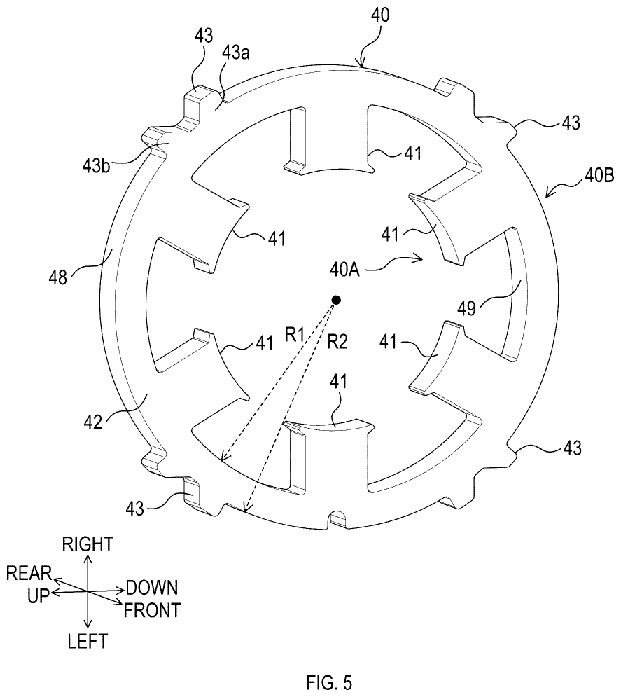

The stator core 40 includes laminated steel plates. The steel plates are metallic sheets made primarily of iron. The stator core 40 has a cylindrical or circular shape. As shown in FIG. 5, the stator core 40 has an inner shape 40A and an outer shape 40B. The inner shape 40A refers to a shape radially inward from an inner circumferential surface 49 of the stator core 40, including the inner circumferential surface 49. The outer shape 40B refers to a shape radially outward from the inner circumferential surface 49 of the stator core 40.

The inner shape 40A has teeth 41 that support the coils 34, and an inner diameter R1. Each of the teeth 41 has a specified shape, and protrudes radially inward from the inner circumferential surface 49 of the stator core 40. In the present embodiment, the stator core 40 has six teeth 41. The six teeth 41 are arranged at equal intervals in the circumferential direction. The outer shape 40B has convex engagement portions 43 to be described later, and an outer diameter R2. The inner diameter R1 is a distance from a center of the stator core 40 (that is, a position of the axis of rotation AX) to the inner circumferential surface 49 of the stator core 40. The outer diameter R2 is a distance from the center of the stator core 40 to an outer circumferential surface 48 of the stator core 40.

The first insulator 51 is an electrical insulation member made of synthetic resin. The first insulator 51 has a cylindrical or circular shape. The first insulator 51 is fixed to a front part of the stator 30. The first insulator 51 has protrusions 511 that support the coils 34. The protrusions 511 protrude radially inward from an inner circumferential surface of the first insulator 51. The first insulator 51 has the same number of protrusions 511 as the teeth 41. Rear ends of the protrusions 511 are coupled to front ends of the teeth 41.

The second insulator 52 is an electrical insulation member made of synthetic resin. The second insulator 52 has a cylindrical or circular shape. The second insulator 52 is fixed to a rear part of the stator 30. The second insulator 52 has protrusions 521 that support the coils 34. The protrusions 521 protrude radially inward from an inner circumferential surface of the second insulator 52. The second insulator 52 has the same number of protrusions 521 as the teeth 41. Front ends of the protrusions 521 are coupled to rear ends of the teeth 41.

The coils 34 are wound around the teeth 41 via the first insulator 51 and the second insulator 52 in series connection. More specifically, each of the coils 34 is wound around one of the teeth 41 via the protrusions 511 and the protrusions 521. That is, in the present embodiment, the stator 30 includes six coils 34. Each of the six coils 34 is arranged around the teeth 41, the protrusions 511 and the protrusions 521. The six coils 34 is electrically insulated from the stator core 40 by the first insulator 51 and the second insulator 52.

The six coils 34 are formed by winding a single wire. Adjacent coils 34 in the circumferential direction are coupled by a connection line 341, which is part of the wire. The connection line 341 is positioned between one of the coils 34 and another of the coils 34, and is supported by the second insulator 52.

The power supply line 61 is coupled to the battery pack 3 via the controller 100. The battery pack 3 supplies the drive current to the motor 25 via the controller 100. The controller 100 supplies the drive current from the battery pack 3 to the motor 25, and excites the stator 30.

The power supply line 61 includes a U-phase power supply line 61U, a V-phase power supply line 61V, and a W-phase power supply line 61W. A U-phase drive current is supplied to the U-phase power supply line 61U. A V-phase drive current is supplied to the V-phase power supply line 61V. A W-phase drive current is supplied to the W-phase power supply line 61W.

The six coils 34 include three sets of coils, and each set of coils is assigned to one of a U-phase, a V-phase, and a W-phase. Specifically, a pair of the coils 34 are assigned to each of the U-phase, the V-phase, and the W-phase. A first pair of the coils 34 are assigned to the U-phase, and include a U-phase coil 34U1 and a U-phase coil 34U2. The U-phase coil 34U1 and the U-phase coil 34U2 are arranged to face each other in the radial direction. A second pair of the coils 34 are assigned to the V-phase, and include a V-phase coil 34V1 and a V-phase coil 34V2. The V-phase coil 34V1 and the V-phase coil 34V2 are arranged to face each other in the radial direction. A third pair of the coils 34, are assigned to the W-phase, and include a W-phase coil 34W1 and a W-phase coil 34W2. The W-phase coil 34W1 and the W-phase coil 34W2 are arranged to face each other in the radial direction.

More specifically, in the circumferential direction, the V-phase coil 34V1 is arranged next to the U-phase coil 34U1, and the W-phase coil 34W1 is arranged next to the V-phase coil 34V1. The U-phase coil 34U2 is arranged next to the W-phase coil 34W1, the V-phase coil 34V2 is arranged next to the U-phase coil 34U2, the W-phase coil 34W2 is arranged next to the V-phase coil 34V2, and the U-phase coil 34U1 is arranged next to the W-phase coil 34W2.

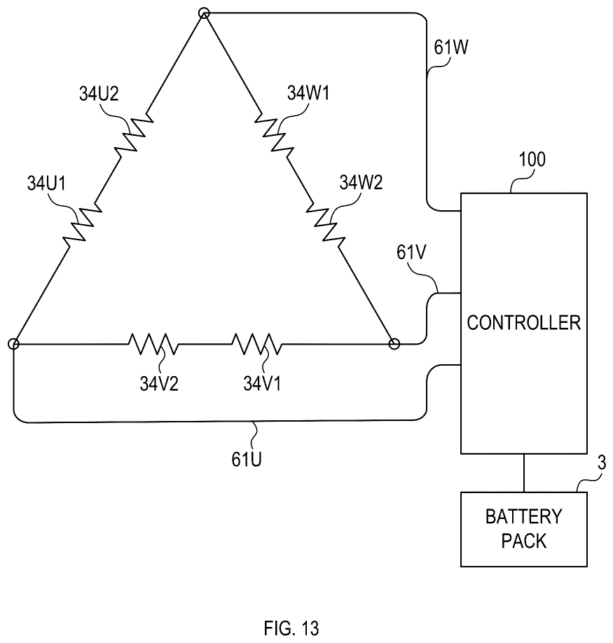

As shown in FIG. 13, the U-phase coils 34U1, 34U2, the V-phase coils 34V1, 34V2, and the W-phase coil 34W1, 34W2 are delta-connected in one series. The U-phase power supply line 61U is coupled to the U-phase coil 34U1 and the V-phase coil 34V2. The V-phase power supply line 61V is coupled to the V-phase coil 34V1 and the W-phase coil 34W2. The W-phase power supply line 61W is coupled to the W-phase coil 34W1 and the U-phase coil 34U2.

The controller 100 controls electric currents flowing to the U-phase coils 34U1, 34U2, the V-phase coils 34V1, 34V2, and the W-phase coils 34W1, 34W2 by switching the electric currents of the U-phase power supply line 61U, the V-phase power supply line 61V and the W-phase power supply line 61W.

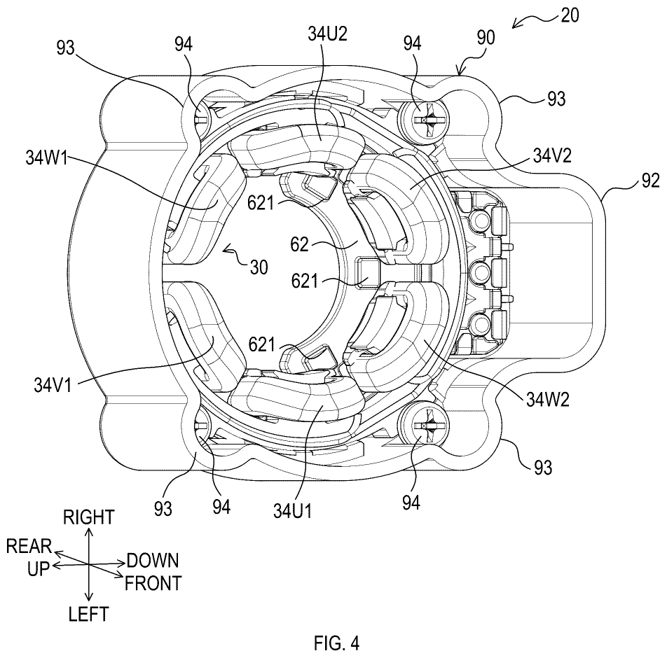

The circuit board 62 is arranged behind the second insulator 52. As shown in FIG. 4, three Hall effect sensors 621 corresponding to the U-phase, the V-phase, and the W-phase are mounted on a front surface of the circuit board 62. The three Hall effect sensors 621 output detection signals to the controller 100 via a signal line. The controller 100 controls the drive currents supplied to the six coils 34 based on the detection signals output from the three Hall effect sensors 621.

### 1-2-1c. Fixing of Stator

Referring to FIGS. 4 through 7, fixing of the stator 30 to the housing 90 will be described. Axial and circumferential positions of the stator 30 are fixed relative to the housing 90.

The housing 90 is an integral cylinder. The housing 90 includes a square protrusion 92, semicircular protrusions 93, and an inner circumferential surface 98. The square protrusion 92 includes a side surface of the housing 90 protruding downward in a square shape. The square protrusion 92 houses the power supply line 61. Each of the semicircular protrusions 93 includes a side surface of the housing 90 protruding radially outward in a semicircular shape. In the present embodiment, the housing 90 includes four semicircular protrusions 93. A screw 94 is inserted to each of the semicircular protrusions 93. The stator 30, after being inserted through an opening of the housing 90, is fixed to the housing 90 by the screws 94. This fixes the axial position of the stator 30 relative to the housing 90.

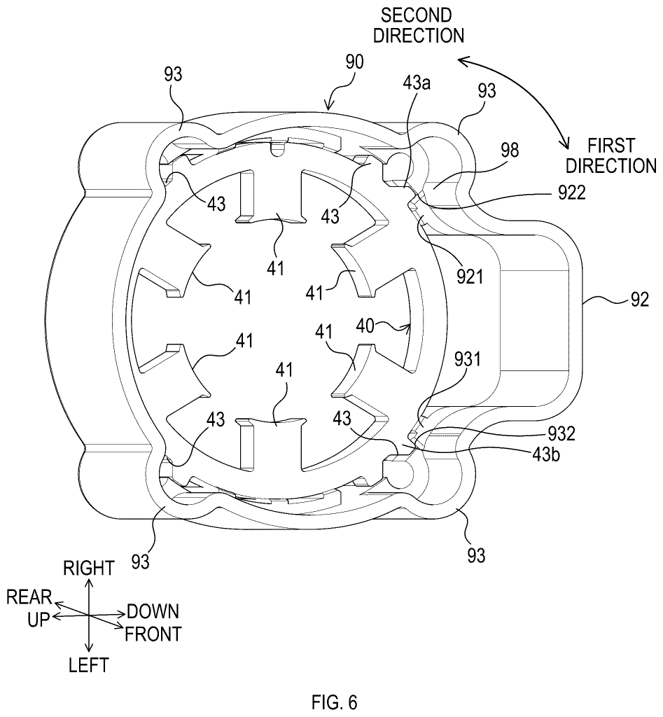

As shown in FIG. 6, one of the semicircular protrusions 93 includes a housing engagement portion 921 arranged on the inner circumferential surface 98 and protruding in the second direction. Another one of the semicircular protrusions 93 includes a housing engagement portion 931 arranged on the inner circumferential surface 98 and protruding in the first direction. The housing engagement portion 921 has a plane 922 parallel to the radial direction. The housing engagement portion 931 has a plane 932 parallel to the radial direction.

As shown in FIG. 5, the outer shape 40B of the stator core 40 includes the convex engagement portions 43. The convex engagement portions 43 are arranged on the outer circumferential surface 48 of the stator core 40 at specified intervals. In the present embodiment, the outer shape 40B includes four convex engagement portions 43.

Each of the convex engagement portions 43 includes a protrusion 43a and a protrusion 43b. The protrusion 43a and the protrusion 43b protrude radially outward from the outer circumferential surface 48 of the stator core 40. The protrusion 43a and the protrusion 43b are arranged side by side in the circumferential direction. When the convex engagement portions 43 are arranged on the stator core 40, a length (height) in the front-rear direction of the stator 30 is reduced compared to a case where the convex engagement portions 43 are arranged in the first insulator 51 or the second insulator 52. Also, since the convex engagement portions 43 are arranged on the stator core 40, vibration is inhibited from being transmitted to the wire via the first insulator 51 or the second insulator 52 that supports the wire. Breakage of the wire is further inhibited. The above-described vibration includes vibration transmitted from an outputter of the first type work machine 1A to the motor 25 and vibration caused by rotation of the motor 25, when the first type work machine 1A is in use.

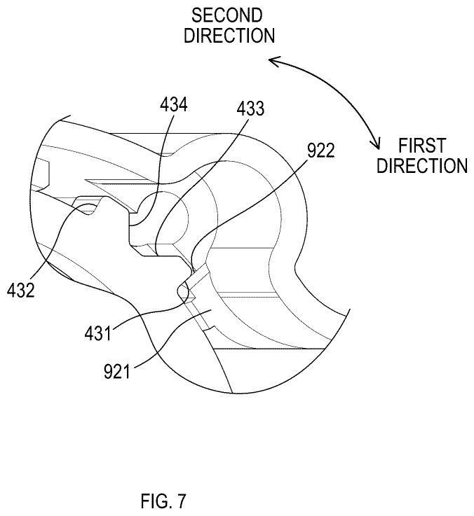

As shown in FIG. 7, the protrusion 43a has a first plane 431 and a third plane 433. The protrusion 43b has a second plane 432 and a fourth plane 434. The first plane 431 and the second plane 432 protrude from the outer circumferential surface 48 of the stator core 40 in parallel to the radial direction. The third plane 433 is inclined from the outer circumferential surface 48 of the stator core 40 toward an outer end of the first plane 431. The fourth plane 434 is inclined from the outer circumferential surface 48 of the stator core 40 toward an outer end of the second plane 432. The third plane 433 and the fourth plane 434 are positioned between the first plane 431 and the second plane 432 in the circumferential direction.

When the stator 30 is housed in the housing 90, one of the convex engagement portions 43 engages the housing engagement portion 921, and another of the convex engagement portions 43 engages the housing engagement portion 931. This fixes the circumferential position of the stator 30 relative to the housing 90. More specifically, rotation in the first direction of the stator 30 is restricted relative to the housing 90 by the first plane 431 of the protrusion 43a included in the one convex engagement portion 43 coming into contact with the plane 922 of the housing engagement portion 921. Also, rotation in the second direction of the stator 30 is restricted relative to the housing 90 by the second plane 432 of the protrusion 43b included in the another convex engagement portion 43 coming into contact with the plane 932 of the housing engagement portion 931.

### <1-2-2. Motor with Half-Split Housing, Concave Stator Core, and Parallel Connection><1-2-2a. Stator>

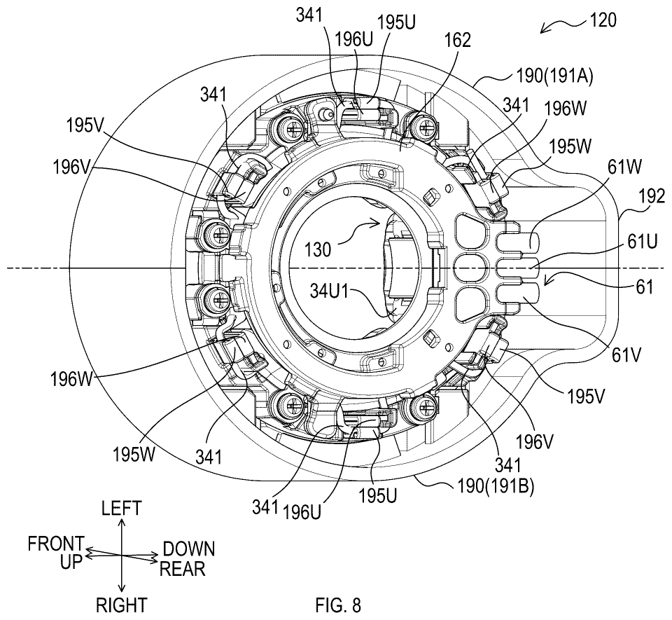

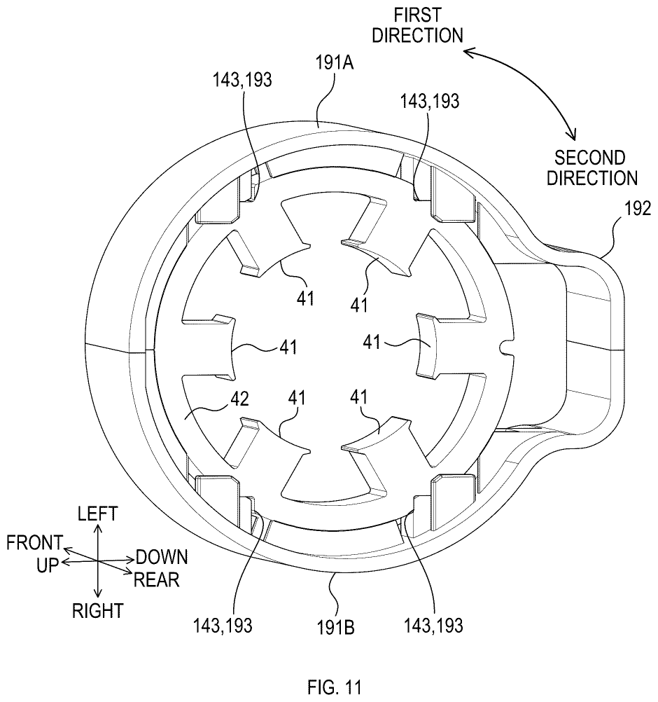

Next, referring to FIGS. 8 through 12, differences between the motor unit 120 included in the second type work machine 1B and the motor unit 20 will be described. The motor unit 120 includes a stator 130 in place of the stator 30, a housing 190 in place of the housing 90, and a circuit board 162 in place of the circuit board 62. Also, the six coils 34 included in the stator 130 are wound around the six teeth 41 in parallel connection.

Similar to the circuit board 62, three Hall effect sensors 621 (not shown) are arranged on a front surface of the circuit board 162.

The stator 130 includes fusing terminals 195 and short-circuit members 196, in addition to the configuration of the stator 30. Also, coils 34 of the stator 130 are arranged in the same manner as the coils 34 of the stator 30. Specifically, in the stator 130, a pair of U-phase coils 34U1, 34U2 are arranged to face each other in the radial direction. A pair of V-phase coils 34V1, 34V2 are arranged to face each other in the radial direction. A pair of W-phase coils 34W1, 34W2 are arranged to face each other in the radial direction.

The fusing terminals 195 are conductive members. The fusing terminals 195 are supported by the second insulator 52, and arranged at equal intervals in the circumferential direction. Each of the fusing terminals 195 is arranged between the adjacent coils 34. The stator 130 has the same number of fusing terminals 195 as the coils 34. In the present embodiment, the stator 130 includes six fusing terminals 195. Specifically, the fusing terminal 195 includes a pair of U-phase fusing terminals 195U, a pair of V-phase fusing terminals 195V, and a pair of W-phase fusing terminals 195W.

One of the U-phase fusing terminals 195U is arranged between the U-phase coil 34U1 and the V-phase coil 34V1. The connection line 341 couples the U-phase coil 34U1 to the V-phase coil 34V1 via the U-phase fusing terminal 195U. The other of the U-phase fusing terminals 195U is arranged between the U-phase coil 34U2 and the V-phase coil 34V2. The connection line 341 couples the U-phase coil 34U2 to the V-phase coil 34V2 via the U-phase fusing terminal 195U.

One of the V-phase fusing terminals 195V is arranged between the V-phase coil 34V1 and the W-phase coil 34W1. The connection line 341 couples the V-phase coil 34V1 to the W-phase coil 34W1 via the V-phase fusing terminal 195V. The other of the V-phase fusing terminals 195V is arranged between the V-phase coil 34V2 and the W-phase coil 34W2. The connection line 341 couples the V-phase coil 34V2 to the W-phase coil 34W2 via the V-phase fusing terminal 195V.

One of the W-phase fusing terminals 195W is arranged between the W-phase coil 34W1 and the U-phase coil 34U1. The connection line 341 couples the W-phase coil 34W1 to the U-phase coil 34U1 via the W-phase fusing terminal 195W. The other of the W-phase fusing terminals 195W is arranged between the W-phase coil 34W2 and the U-phase coil 34U2. The connection line 342 couples the W-phase coil 34W2 to the U-phase coil 34U2 via the W-phase fusing terminal 195W.

The short-circuit members 196 are plate-shaped conductive members. Each of the short-circuit members 196 is curved so as to follow a shape of the stator 130, and is arranged in front of the circuit board 162. The stator 130 has the same number of short-circuit members 196 as the phases of the coils 34. In the present embodiment, the short-circuit members 196 include a U-phase short-circuit member 196U, a V-phase short-circuit member 196V, and a W-phase short-circuit member 196W.

The U-phase short-circuit member 196U couples (that is, short circuits) the pair of U-phase fusing terminals 195U and the U-phase power supply line 61U. The V-phase short-circuit member 196V couples (that is, short circuits) the pair of V-phase fusing terminals 195V and the V-phase power supply line 61V. The W-phase short-circuit member 196W couples (that is, short circuits) the pair of W-phase fusing terminals 195W and the W-phase power supply line 61W.

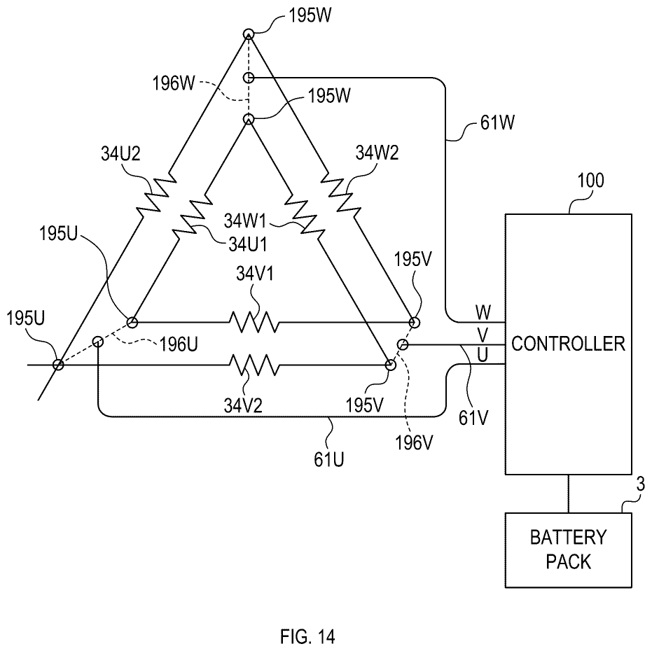

As shown in FIG. 14, the U-phase coil 34U1, the V-phase coil 34V1 and the W-phase coil 34W1 are coupled to form a first delta connection. The U-phase coil 34U2, the V-phase coil 34V2 and the W-phase coil 34W2 are coupled to form a second delta connection. The first delta connection is coupled in parallel to the second delta connection. Accordingly, in the present embodiment, the six coils 34 are delta-connected in two parallel.

### 1-2-2b. Fixing of Stator

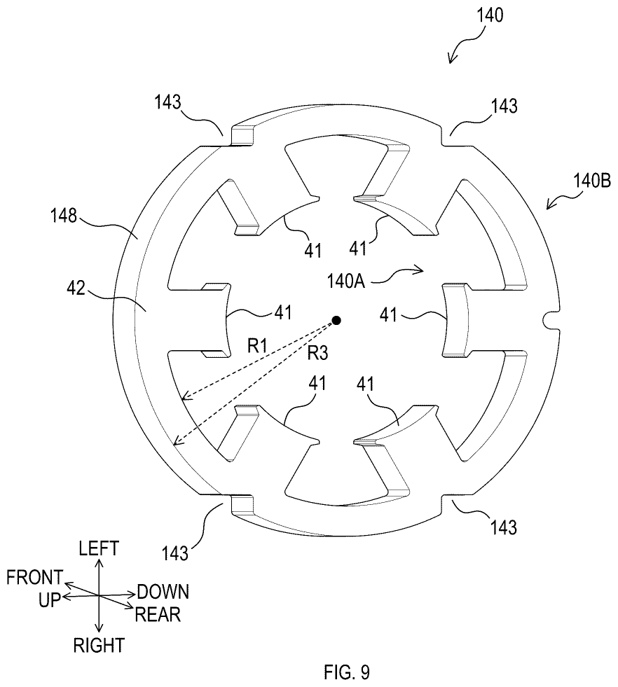

Next, referring to FIGS. 9 through 12, fixing of the stator 130 to the housing 190 will be described. Axial and circumferential positions of the stator 130 are fixed relative to the housing 190.

As shown in FIG. 9, the stator 130 includes a stator core 140 in place of the stator core 40. The stator core 140 includes multiple laminated steel plates. The stator core 140 has an inner shape 40A and an outer shape 140B. Specifically, the stator core 140 has the inner shape common to that of the stator core 40, and an outer shape different from that of the stator core 40.

The outer shape 140B has concave engagement portions 143, and an outer diameter R3. The outer diameter R3 may be the same as or may be different from the outer diameter R2. Each of the concave engagement portions 143 differs in shape from the convex engagement portion 43. The concave engagement portions 143 are arranged radially outward of some of the teeth 41. In the present embodiment, the outer shape 140B has four concave engagement portions 143. The four concave engagement portions 143 are arranged radially outward of four of the six teeth 41.

Each of the concave engagement portions 143 is recessed (concave) radially inward from an outer circumferential surface 148 of the stator core 140. When recesses are formed in the outer circumferential surface 148, a magnetic path of the stator core 140 becomes narrow and magnetic resistance increases, as compared to a case where no recess is formed in the outer circumferential surface 148. However, the magnetic path where the teeth 41 are arranged in the stator core 140 is relatively wide. Thus, when the concave engagement portions 143 are arranged radially outward of the teeth 41, a rate of increase in magnetic resistance is reduced as compared to a case where the concave engagement portions 143 are arranged radially outward of a portion where the teeth 41 are not arranged.

The stator core 140 has the inner shape 40A common to that of the stator core 40. The stator cores 40, 140 are punched by a progressive die. Progressive processing using a progressive die includes a series of coupled steps in which partial punching is performed, and material is punched out one after the other while automatically being sent to the next step with each press stroke. The stator core 140 is produced by adding a step of cutting away a part of the outer circumference to the progressive processing of the stator core 40. Whether to cut away a part of the outer circumference can be easily switched by changing a blade position using a hydraulic pressure. Thus, the stator core 40 and the stator core 140 can be manufactured on the same production line. Accordingly, it is possible to simplify production facilities for multiple types of electric work machines including the first type work machine 1A and the second type work machine 1B.

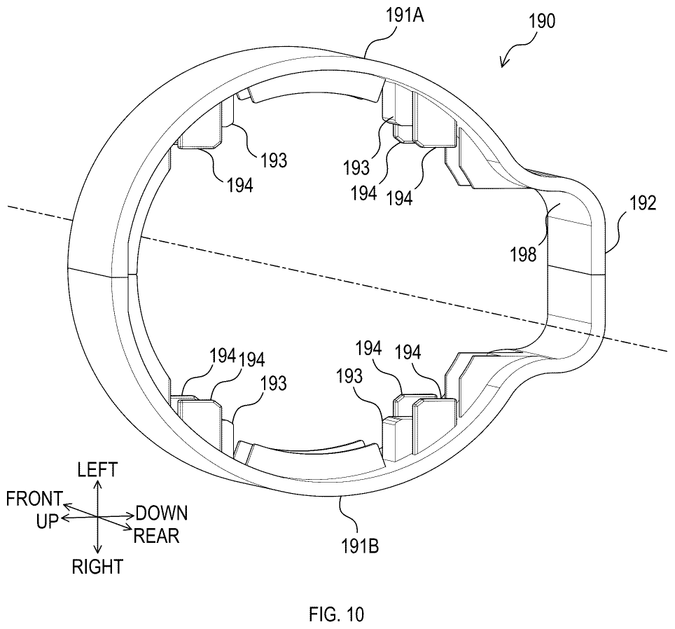

As shown in FIG. 10, the housing 190 is a cylinder, and constituted by a pair of half-split bodies 191A, 191B. The half-split body 191A forms a left half of the housing 190, and the half-split body 191B forms a right half of the housing 190. The half-split body 191A is assembled from left to the stator 130, and the half-split body 191B is assembled from right to the stator 130.

The housing 190 includes a square protrusion 192, housing engagement portions 193, and pairs of restriction members 194. Each of the housing engagement portions 193 differs in shape from the housing engagement portions 921, 931. The square protrusion 192 includes a side surface of the housing 190 protruding in a square shape. The square protrusion 192 houses the power supply line 61. The housing 190 has the same number of housing engagement portions 193 as the number of concave engagement portions 143. In the present embodiment, the housing engagement portions 193 include four housing engagement portions 193. Also, in the present embodiment, the pairs of restriction members 194 include four pairs of restriction members 194.

The four housing engagement portions 193 are arranged to face the concave engagement portions 143 on an inner circumferential surface 198 of the housing 190. Each of the housing engagement portions 193 protrudes radially inward from the inner circumferential surface 198 of the housing 190. When the half-split bodies 191A, 191B are assembled to the stator 130, each of the four concave engagement portions 143 engages the corresponding one of the four housing engagement portions 193. This restricts rotation in the first direction and the second direction of the stator 130 relative to the housing 190. Specifically, the circumferential position of the stator 130 is fixed relative to the housing 190.

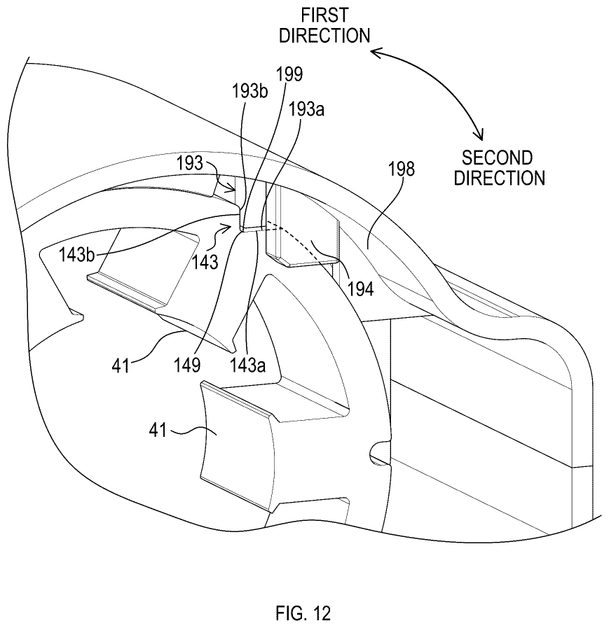

More specifically, as shown in FIG. 12, each of the housing engagement portions 193 has a first plane 193a, a second plane 193b, and a connecting portion 199. Each of the concave engagement portions 143 has a third plane 143a, a fourth plane 143b, and a connecting portion 149. The shortest direction from the first plane 193a toward the second plane 193b is aligned with the first direction. The first plane 193a and the second plane 193b are inclined toward a tip end of the housing engagement portion 193 from the inner circumferential surface 198 of the housing 190. The connecting portion 199 couples the first plane 193a and the second plane 193b. The connecting portion 199 protrudes radially inward from the inner circumferential surface 198 of the housing 190.

The shortest direction from the third plane 143a toward the fourth plane 143b is aligned with the first direction. The third plane 143a and the fourth plane 143b are inclined toward a center of the concave engagement portion 143 from the outer circumferential surface 148 of the stator core 140. The connecting portion 149 is positioned between the third plane 143a and the fourth plane 143b and couples the third plane 143a and the fourth plane 143b. The connecting portion 199 is recessed radially inward from the outer circumferential surface 148 of the stator core 140.

By the concave engagement portions 143 engaging the housing engagement portions 193, the first plane 193a contacts the third plane 143a, and rotation in the first direction of the stator 130 is restricted relative to the housing 190. Also, by the concave engagement portions 143 engaging the housing engagement portions 193, the second plane 193b contacts the fourth plane 143b, and rotation in the second direction of the stator 130 is restricted relative to the housing 190.

The four pairs of restriction members 194 overlap with the housing engagement portions 193 in the axial direction. Each of the pair of restriction members 194 is a plate member, and protrudes radially inward from the inner circumferential surface 198 of the housing 190. By the four pairs of restriction members 194, movement of the stator 130 in the axial direction is restricted relative to the housing 190. More specifically, one of the pair of restriction members 194 is arranged ahead of the housing engagement portion 193 at a specified interval from the housing engagement portion 193. This restricts forward movement of the stator 130 relative to the housing 190. Also, the other of the pair of restriction members 194 is arranged behind the housing engagement portion 193 at a specified interval from the housing engagement portion 193. This restricts rearward movement of the stator 130 relative to the housing 190.

In the present embodiment, the second type work machine 1B corresponds to one example of the first type of work machine of the present disclosure, and the first type work machine 1A corresponds to one example of the second type of work machine of the present disclosure. Also, the housing engagement portions 193 correspond to one example of the first engagement portion and the housing protrusion of the present disclosure, the concave engagement portions 143 correspond to one example of the second engagement portion and the stator recess of the present disclosure, the housing engagement portions 921, 931 correspond to one example of the third engagement portion of the present disclosure, and the convex engagement portions 43 correspond to one example of the fourth engagement portion and the stator protrusion of the present disclosure. Or, the first type work machine 1A corresponds to one example of the first type of work machine of the present disclosure, the second type work machine 1B corresponds to one example of the second type of work machine of the present disclosure, the housing engagement portions 921, 931 correspond to one example of the first engagement portion of the present disclosure, the convex engagement portions 43 correspond to one example of the second engagement portion and the stator protrusion of the present disclosure, the housing engagement portions 193 correspond to one example of the third engagement portion of the present disclosure, and the concave engagement portions 143 correspond to one example of the fourth engagement portion and the stator recess of the present disclosure.

### 1-3. Effect

According to the first embodiment detailed above, the following effects are achieved.

(1) The stator core 40 of the first type work machine 1A has the common inner shape 40A with the stator core 140 of the second type work machine 1B. This allows part of the production line for the first type work machine 1A to be shared with part of the production line for the second type work machine 1B, and thereby simplify production facilities.

(2) In the second type work machine 1B, the concave engagement portions 143 of the stator core 140 are arranged radially outward of the teeth 41. Thus, increase in magnetic resistance of the stator core 140 due to forming recesses on the outer circumferential surface 148 of the stator core 140 can be inhibited.

(3) In the second type work machine 1B, two surfaces of the concave engagement portion 143 engage two surfaces of the housing engagement portion 193. This allows the circumferential position of the stator 130 to be strongly fixed relative to the housing 90.

(4) In the second type work machine 1B, since the stator 130 includes the fusing terminals 195 and the short-circuit members 196, the coils 34 can be easily coupled in parallel.

(5) In the first type work machine 1A, the convex engagement portions 43 are arranged on the stator core 40. This allows an axial height of the stator 30 to be reduced. Further, vibration is inhibited from being transmitted to the coils 34, and breakage of the coils 34 can be inhibited.

(6) In the second type work machine 1B, the concave engagement portions 143 are arranged on the stator core 140. This allows an axial height of the stator 130 to be reduced. Further, breakage of the coils 34 can be inhibited.

### 2. Second Embodiment

### 2-1. Differences from First Embodiment

The second embodiment has a basic configuration similar to the first embodiment, and thus the differences from the first embodiment are described below. The same reference numerals as those in the first embodiment indicate the same configuration, and refer to the preceding descriptions.

A work machine group according to the second embodiment includes a first type work machine 1C and the second type work machine 1B. The first type work machine 1C differs from the first type work machine 1A in that the first type work machine 1C includes a motor unit 220 in place of the motor unit 20.

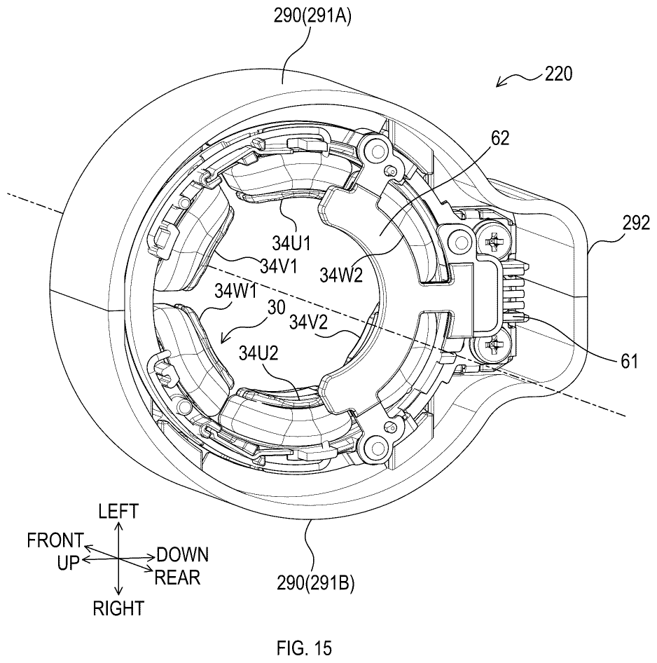

As shown in FIG. 15, the motor unit 220 differs from the motor unit 20 in that the motor unit 220 includes a housing 290 in place of the housing 90. Similar to the motor unit 20, the motor unit 220 includes the rotor 70, the stator 30, and the circuit board 62. The six coils 34 of the stator 30 are delta-connected in one series.

### 2-2. Motor with Half-Split Housing, Convex Stator Core, and Series Connection

### 2-2-1. Fixing of Stator

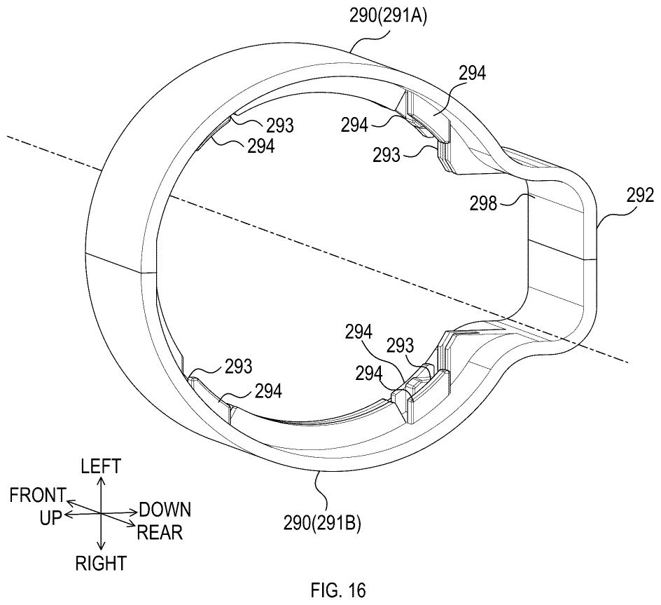

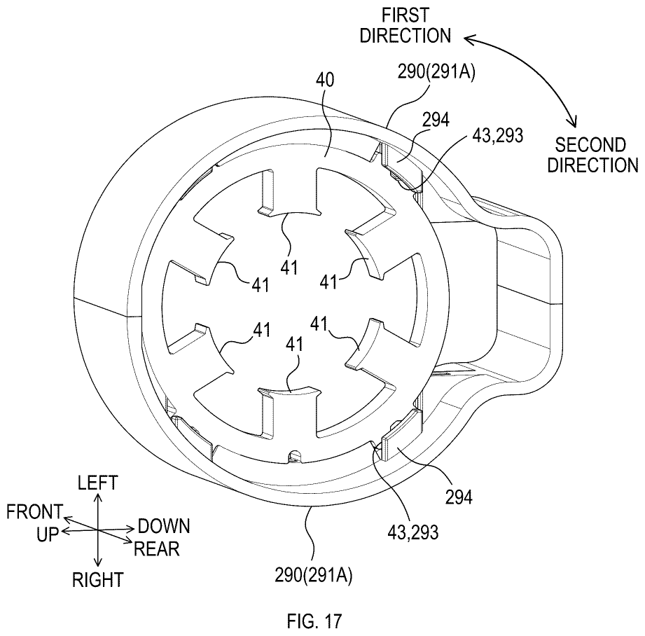

As shown in FIG. 16, the housing 290 is a cylinder, and constituted by a pair of half-split bodies 291A, 291B. The half-split body 291A forms a left half of the housing 290, and the half-split body 291B forms a right half of the housing 290. The half-split body 291A is assembled from left to the stator 30, and the half-split body 291B is assembled from right to the stator 30.

The housing 290 includes a square protruding portion 292, housing engagement portions 293, and pairs of restriction members 294. The square protruding portion 292 includes a side surface of the housing 290 protruding in a square shape. The square protruding portion 292 houses the power supply line 61. The housing 290 includes the same number of housing engagement portions 293 as the number of convex engagement portions 43. In the present embodiment, the housing engagement portions 293 include four housing engagement portions 293. Also, in the present embodiment, the pairs of restriction members 294 include four pairs of restriction members 294.

The four housing engagement portions 293 face the convex engagement portions 43 on an inner circumferential surface 298 of the housing 290. Each of the housing engagement portions 293 protrudes radially inward from the inner circumferential surface 298 of the housing 290. When the half-split bodies 291A, 291B are assembled to the stator 30, each of the four convex engagement portions 43 engages the corresponding one of the four housing engagement portions 293. This restricts rotation in the first direction and the second direction of the stator 30 relative to the housing 290. That is, the circumferential position of the stator 30 is fixed relative to the housing 290.

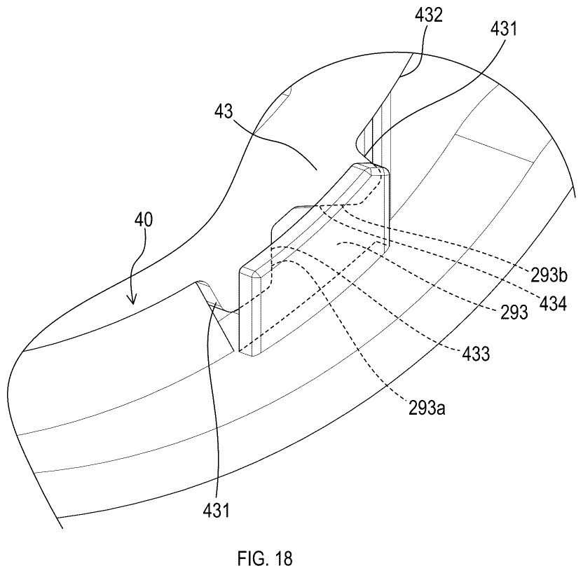

More specifically, as shown in FIG. 18, each of the housing engagement portions 293 has a first plane 293a and a second plane 293b. The shortest direction from the first plane 293a toward the second plane 293b is aligned with the first direction. The first plane 293a and the second plane 293b are inclined toward a tip end of the housing engagement portion 293 from the inner circumferential surface 298 of the housing 290.

By the convex engagement portion 43 engaging the corresponding housing engagement portion 293, the first plane 293a of the housing engagement portion 293 contacts the third plane 433 of the convex engagement portion 43, and the rotation in the first direction of the stator 30 is restricted relative to the housing 290. Also, by the convex engagement portion 43 engaging the housing engagement portion 293, the second plane 293b of the housing engagement portion 293 contacts the fourth plane 434 of the convex engagement portion 43, and the rotation in the second direction of the stator 30 is restricted relative to the housing 290.

The four pairs of restriction members 294 overlap the housing engagement portions 293 in the axial direction. Each of the pairs of restriction members 294 is a plate member and protrudes radially inward from the inner circumferential surface 298 of the housing 290. The four pairs of restriction members 294 restrict axial movement of the stator 30 relative to the housing 290. More specifically, one of a pair of restriction members 294 is arranged ahead of the corresponding housing engagement portion 293 at a specific interval from the housing engagement portions 293. This restricts forward movement of the stator 30 relative to the housing 290. Also, the other of the pair of restriction members 194 is arranged behind the housing engagement portion 293 at a specific interval from the housing engagement portions 293. This restricts rearward movement of the stator 30 relative to the housing 290.

In the present embodiment, the second type work machine 1B corresponds to one example of the first type of work machine of the present disclosure, the first type work machine 1C corresponds to one example of the second type of work machine of the present disclosure, the housing engagement portions 193 correspond to one example of the first engagement portion and the housing protrusion of the present disclosure, the concave engagement portions 143 correspond to one example of the second engagement portion and the stator recess of the present disclosure, the housing engagement portions 293 correspond to one example of the third engagement portion of the present disclosure, and the convex engagement portions 43 correspond to one example of the fourth engagement portion and the stator protrusion of the present disclosure. Or, the first type work machine 1C corresponds to one example of the first type of work machine of the present disclosure, the second type work machine 1B corresponds to one example of the second type of work machine of the present disclosure, the housing engagement portions 293 correspond to one example of the first engagement portion of the present disclosure, the convex engagement portions 43 correspond to one example of the second engagement portion and the stator protrusion of the present disclosure, the housing engagement portions 293 correspond to one example of the third engagement portion of the present disclosure, and the concave engagement portions 143 correspond to one example of the fourth engagement portion and the stator recess of the present disclosure.

### 2-3. Effect

According to the second embodiment detailed above, the same effects as the effects (1) through (6) of above-described the first embodiment are achieved.

### 3. Third Embodiment

### 3-1. Differences from First Embodiment

The third embodiment has a basic configuration similar to the first embodiment, and thus the differences from the first embodiment are described below. The same reference numerals as those in the second embodiment indicate the same configuration, and refer to the preceding descriptions.

A work machine group according to the third embodiment includes a first type work machine 1D and the second type work machine 1B. The first type work machine 1D differs from the first type work machine 1A in that the first type work machine 1D includes a motor unit 320 in place of the motor unit 20.

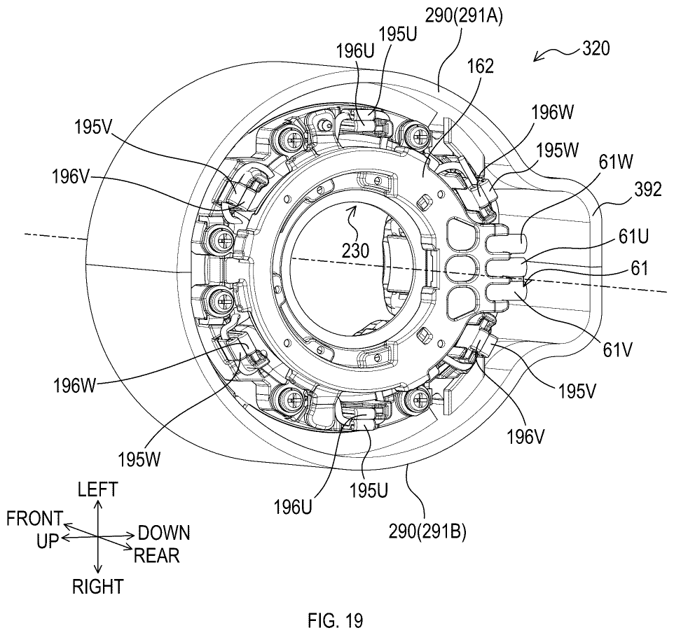

As shown in FIG. 19, the first type work machine 1D differs from the first type work machine 1A in that the motor unit 320 includes a housing 290 in place of the housing 90, a stator 230 in place of the stator 30, and the circuit board 162 in place of the circuit board 62. The motor unit 320 includes the rotor 70 as in the motor unit 20.

### 3-2. Motor with Half-Split Housing, Convex Stator Core, and Parallel Connection

### 3-2-1. Fixing of Stator

The stator 230 includes the stator core 40, the pair of U-phase fusing terminals 195U, the pair of V-phase fusing terminals 195V, the pair of W-phase fusing terminals 195W, the U-phase short-circuit member 196U, the V-phase short-circuit member 196V, and the W-phase short-circuit member 196W. Similar to the stator 130, the six coils 34 of the stator 230 are delta-connected in two parallel. That is, the stator 230 differs from the stator 130 in that the stator 230 includes the stator core 40 in place of the stator core 140.

Similar to the second embodiment, when the half-split bodies 291A, 291B are assembled to the stator 130, each of the four convex engagement portions 43 engage the corresponding one of the four housing engagement portions 293. This restricts rotation in the first direction and the second direction of the stator 230 relative to the housing 290. Further, the four pairs of restriction members 294 restrict axial movement of the stator 230 relative to the housing 290.

In the present embodiment, the second type work machine 1B corresponds to one example of the first type of work machine of the present disclosure, the first type work machine 1D corresponds to one example of the second type of work machine of the present disclosure, the housing engagement portions 193 correspond to one example of the first engagement portion and the housing protrusion of the present disclosure, the concave engagement portions 143 correspond to one example of the second engagement portion and the stator recess of the present disclosure, the housing engagement portions 293 correspond to one example of the third engagement portion of the present disclosure, and the convex engagement portions 43 correspond to one example of the fourth engagement portion and the stator protrusion of the present disclosure. Or, the first type work machine 1D corresponds to one example of the first type of work machine of the present disclosure, the second type work machine 1B corresponds to one example of the second type of work machine of the present disclosure, the housing engagement portions 293 correspond to one example of the first engagement portion of the present disclosure, the convex engagement portions 43 correspond to one example of the second engagement portion and the stator protrusion of the present disclosure, the housing engagement portions 193 correspond to one example of the third engagement portion of the present disclosure, and the concave engagement portions 143 correspond to one example of the second engagement portion and the stator recess of the present disclosure.

### 3-3. Effect

According to the third embodiment detailed above, the same effects as the effects (1) through (6) of above-described the first embodiment are achieved.

### 4. Fourth Embodiment

### 4-1. Differences from First Embodiment

The fourth embodiment has a basic configuration similar to the first embodiment, and thus the differences from the first embodiment are described below. The same reference numerals as those in the first embodiment indicate the same configuration, and refer to the preceding descriptions.

A work machine group according to the fourth embodiment includes a first type work machine 1E and the second type work machine 1B. The first type work machine 1E differs from the first type work machine 1A in that the first type work machine 1E includes a motor unit 420 in place of the motor unit 20.

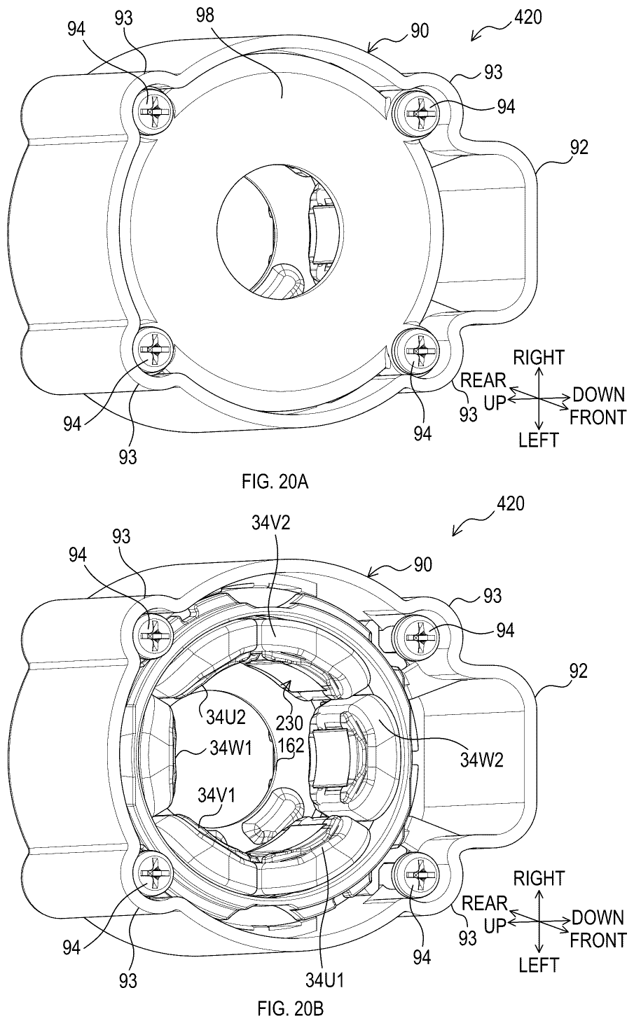

As shown in FIG. 20B, the motor unit 420 differs from the motor unit 20 in that the motor unit 420 includes the stator 230 in place of the stator 30, and the circuit board 162 in place of the circuit board 62. The motor unit 420 includes the rotor 70 and the housing 90 as in the motor unit 20.

### 4-2. Motor with Cylindrical Housing, Convex Stator Core, and Parallel Connection

### 4-2-1. Fixing of Stator

As shown in FIG. 20A, similar to the first embodiment, when the housing 90 houses the stator 230, the stator 230 is screwed to the housing 90 via a baffle plate 98 with screws 94. The screws 94 are not in contact with the stator 230. FIG. 20B shows the stator 230 in FIG. 20A without the baffle plate 98. By screwing the stator 230 to the housing 90 via the baffle plate 98 with the screws 94, an axial position of the stator 230 is fixed relative to the housing 90. Also, when the housing 90 houses the stator 230, one of the convex engagement portions 43 engages the housing engagement portion 921, and another one of the convex engagement portions 43 contacts the housing engagement portion 931. This fixes a circumferential position of the stator 230 relative to the housing 90.

In the present embodiment, the second type work machine 1B corresponds to one example of the first type of work machine of the present disclosure, the first type work machine 1E corresponds to one example of the second type of work machine of the present disclosure, the housing engagement portions 193 correspond to one example of the first engagement portion and housing protrusion of the present disclosure, the concave engagement portions 143 correspond to one example of the second engagement portion and the stator recess of the present disclosure, the housing engagement portions 921, 931 correspond to one example of the third engagement portion of the present disclosure, and the convex engagement portions 43 correspond to one example of the fourth engagement portion and the stator protrusion of the present disclosure. Or, the first type work machine 1E corresponds to one example of the first type of work machine of the present disclosure, the second type work machine 1B corresponds to one example of the second type of work machine of the present disclosure, the housing engagement portions 921, 931 correspond to one example of the first engagement portion of the present disclosure, the convex engagement portions 43 correspond to one example of the second engagement portion and the stator protrusion of the present disclosure, the housing engagement portions 193 correspond to one example of the third engagement portion of the present disclosure, and the concave engagement portions 143 correspond to one example of the fourth engagement portion and the stator recess of the present disclosure.

### 4-3. Effect

According to the fourth embodiment detailed above, the same effects as the effects (1) through (6) of above-described the first embodiment are achieved.

### 5. Fifth Embodiment

### 5-1. Differences from First Embodiment

The fifth embodiment has a basic configuration similar to the first embodiment, and only the differences from the first embodiment are described below. The same reference numerals as those in the first embodiment indicate the same configuration, and refer to the preceding descriptions.

A work machine group according to the fifth embodiment includes the first type work machine 1A and a second type work machine 1F. The second type work machine 1F differs from the second type work machine 1B in that the second type work machine 1F includes a motor unit 520 in place of the motor unit 120.

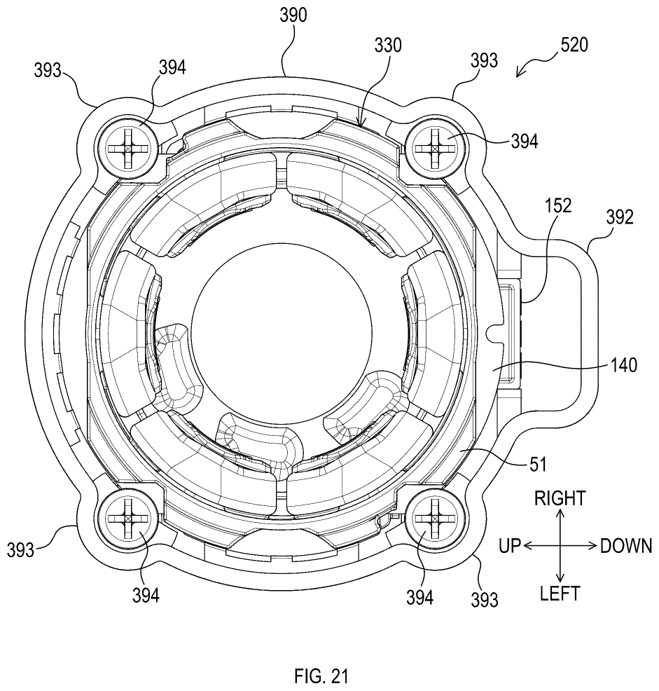

As shown in FIG. 21, the motor unit 520 differs from the motor unit 120 in that the motor unit 520 includes a housing 390 in place of the housing 190, and a stator 330 in place of the stator 130. The stator 330 differs from the stator 130 in that the stator 330 includes a second insulator 152 in place of the second insulator 52. The motor unit 520 includes the rotor 70, the stator 330, and the circuit board 162. The six coils 34 of the stator 330 are delta-connected in two parallel.

### 5-2. Motor with Cylindrical Housing, Concave Stator Core, and Parallel Connection

### 5-2-1. Fixing of Stator

Referring to FIGS. 21 through 24, fixing of the stator 330 to the housing 390 will be described. The housing 390 is an integral cylinder. The housing 390 includes a square protruding portion 392 and semicircular protruding portions 393. The square protruding portion 392 includes a side surface of the housing 390 protruding downward in a square shape. The square protruding portion 392 has a right side surface, a left side surface, and a lower surface. The right side surface extends downward from the side surface of the housing 390. The left side surface extends from the side surface of the housing 390, and is located closer to the left side than the right side surface. The lower surface couples the right side surface and the left side surface. The square protruding portion 392 houses the power supply line 61.

Each of the semicircular protruding portions 393 includes the side surface of the housing 390 protruding radially outward in a semicircular shape. In the present embodiment, the housing 390 includes four semicircular protruding portions 393. A screw 394 is inserted to each of the semicircular protruding portions 393. The stator 330, after being inserted from an opening of the housing 390, is fixed to the housing 390 with the screws 394. This fixes an axial position of the stator 330 relative to the housing 390.

The square protruding portion 392 includes two housing engagement portions 395. The two housing engagement portions 395 are plate-shaped members. One of the two housing engagement portions 395 extends leftward from an upper end of the right side surface of the square protruding portion 392. The other of the two housing engagement portions 395 extends rightward from an upper end of the left side surface of the square protruding portion 392. A left end of one of the two housing engagement portions 395 faces a right end of the other of the two housing engagement portions 395.

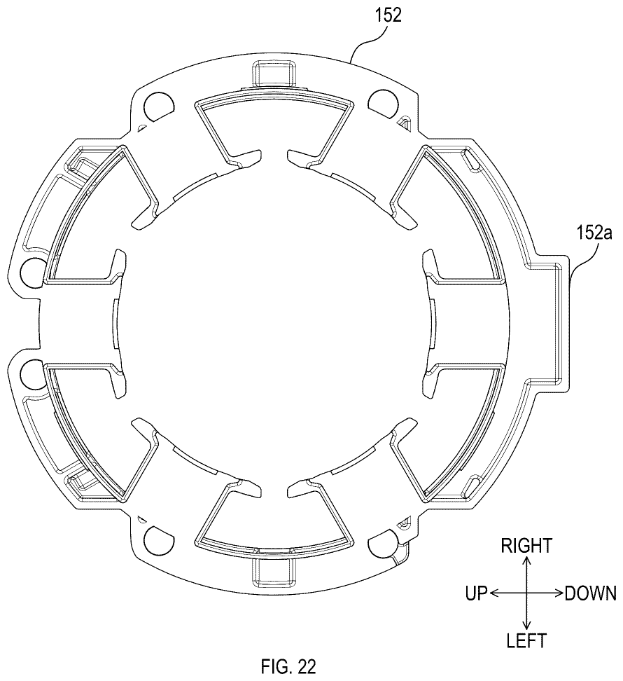

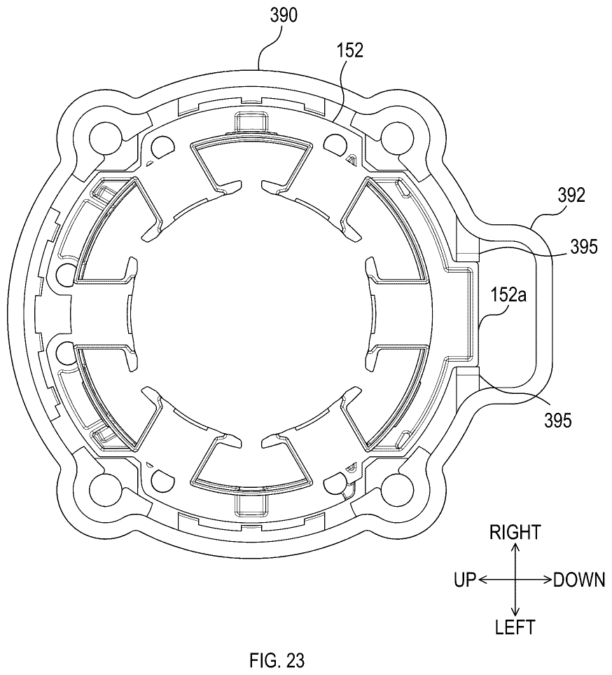

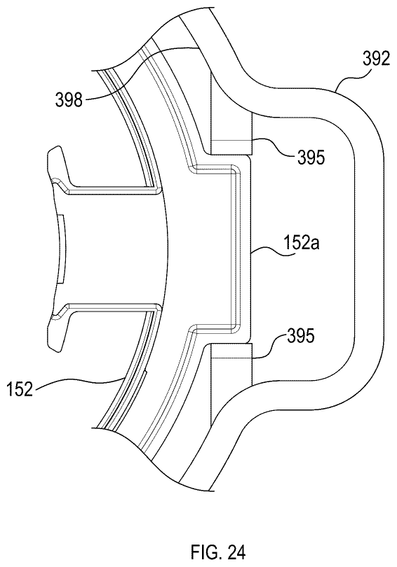

As shown in FIG. 22, the second insulator 152 includes a protruding engagement portion 152a. The protruding engagement portion 152a has a square shape, and protrudes radially outward from an outer circumferential surface of the second insulator 152. As shown in FIGS. 23 and 24, when the housing 390 houses the stator 130, the protruding engagement portion 152a of the second insulator 152 comes into contact with the two housing engagement portions 395. This fixes a circumferential position of the stator 330 relative to the housing 390. That is, in the present embodiment, the housing engagement portions 395 engage the protruding engagement portion 152a of the second insulator 152.

Engagement of the protruding engagement portion 152a and the right-side housing engagement portion 395 restricts rotation in the second direction of the stator 330 relative to the housing 390. Engagement of the protruding engagement portion 152a and the left-side housing engagement portion 395 restricts rotation in the first direction of the stator 330 relative to the housing 390.

In the present embodiment, the second type work machine 1F corresponds to one example of the first type of work machine of the present disclosure, the first type work machine 1A corresponds to one example of the second type of work machine of the present disclosure, the housing engagement portions 395 correspond to one example of the first engagement portion of the present disclosure, the protruding engagement portion 152a of the second insulator 152 corresponds to one example of the second engagement portion of the present disclosure, the housing engagement portions 921, 931 correspond to one example of the third engagement portion of the present disclosure, and the convex engagement portions 43 correspond to one example of the fourth engagement portion of the present disclosure. Or, the first type work machine 1A corresponds to one example of the first type of work machine of the present disclosure, the second type work machine 1F corresponds to one example of the second type of work machine of the present disclosure, the housing engagement portions 921, 931 correspond to one example of the first engagement portion of the present disclosure, the convex engagement portions 43 correspond to one example of the second engagement portion of the present disclosure, the housing engagement portions 395 correspond to one example of the third engagement portion of the present disclosure, and the protruding engagement portion 152a corresponds to one example of the fourth engagement portion of the present disclosure.

### 5-3. Effect

According to the fifth embodiment detailed above, the same effect as the effect (4) of above-described the first embodiment and the following effect are achieved.

(7) In the second type work machine 1F, by the protruding engagement portion 152a of the second insulator 152 engaging the two housing engagement portions 395, a circumferential position of the stator 33 can be fixed relative to the housing 390.

### 6. Other Embodiments

The embodiments of the present disclosure have been described in the above. The present disclosure is not limited to the above-described embodiments, and can be practiced in various forms.

(a) The work machine group according to the fifth embodiment includes the first type work machine 1A and the second type work machine 1F, but may include any of the first type work machines 1C, 1D, 1E and the second type work machine 1F.

(b) In the above-described embodiments, the convex engagement portions 43 are integrally formed with the stator core 40, but the convex engagement portions 43 may be formed separately from the stator core 40. Specifically, when the first insulator 51 and the second insulator 52 are integrally formed with the stator core 40 and fixed to the stator core 40, the convex engagement portions 43 may be made of synthetic resin integrally with the first insulator 51 or the second insulator 52. When the convex engagement portions 43 are integrally formed with the first insulator 51, the convex engagement portions 43 are formed to extend rearward from the first insulator 51 and contact the outer circumferential surface 48 of the stator core 40. When the convex engagement portions 43 are integrally formed with the second insulator 52, the convex engagement portions 43 are formed to extend forward from the second insulator 52 and contact the outer circumferential surface 48 of the stator core 40.

What is claimed is:

1. An electric work machine corresponding to a first type of work machine in a work machine group including the first type of work machine and a second type of work machine,
the first type of work machine comprising:
a first brushless motor including first coils and a first stator, the first stator having an inner shape and a first outer shape, the inner shape having teeth and a specified inner diameter, each of the teeth having a specified shape;
a controller configured to excite the first stator; and
a first housing configured to house the first brushless motor,
the second type of work machine comprising:
a second brushless motor including second coils and a second stator, the second stator having the inner shape common to that of the first stator and a second outer shape different from the first outer shape; and
a second housing configured to house the second brushless motor.

2. The electric work machine according to claim 1, wherein
the first housing has a first inner circumferential surface, and a first engagement portion arranged on the first inner circumferential surface,
the first outer shape has a first outer circumferential surface and a second engagement portion, the first outer circumferential surface facing the first inner circumferential surface, the second engagement portion being arranged on the first outer circumferential surface and configured to engage the first engagement portion,
the second housing has a second inner circumferential surface and a third engagement portion, the third engagement portion being arranged on the second inner circumferential surface and different in shape from the first engagement portion,
the second outer shape has a second outer circumferential surface and a fourth engagement portion, the second outer circumferential surface facing the second inner circumferential surface, the fourth engagement portion being arranged on the second outer circumferential surface, different in shape from the second engagement portion, and configured to engage the third engagement portion.

3. The electric work machine according to claim 2, wherein
the second engagement portion has a stator recess indented radially inward from the first outer circumferential surface, and
the fourth engagement portion has a stator protrusion projecting radially outward from the first outer circumferential surface.

4. The electric work machine according to claim 3, wherein the stator recess is arranged radially outward of at least one of the teeth.

5. The electric work machine according to claim 3, wherein
the first engagement portion has a housing protrusion projecting
radially inward from the first inner circumferential surface,
the housing protrusion has a first plane, a second plane, and a first coupling portion between the first plane and the second plane, the first coupling portion projecting radially inward from the first inner circumferential surface,
the stator recess has a third plane, a fourth plane, and a second coupling portion between the third plane and the fourth plane, the second coupling portion being indented radially inward from the first outer circumferential surface, and
in a state where the housing protrusion is engaged with the stator recess, the first plane is in contact with the third plane and the second plane is in contact with the fourth plane.

6. The electric work machine according to claim 3, wherein
the first coils are wound around the teeth in parallel connection.

7. The electric work machine according to claim 6, wherein
the first stator further includes a first fusing terminal and a second fusing terminal, and a short-circuit member,
the first coils include two first phase coils corresponding to a first phase of the motor, and two second phase coils corresponding to a second phase of the motor,
one of the two first phase coils is disposed adjacent to one of the two second phase coils, and coupled to the one of the second phase coils via the first fusing terminal,
the other of the two first phase coils is disposed adjacent to the other of the two second phase coils, and coupled to the other of the second phase coils via the second fusing terminal, and
the short-circuit member couples the first fusing terminal to the second fusing terminal.

8. The electric work machine according to claim 1, wherein
the first stator includes a first stator core having the inner shape and the first outer shape, and
the second stator includes a second stator core having the inner shape and the second outer shape.

9. The electric work machine according to claim 2, wherein
the second engagement portion has a stator protrusion projecting radially outward from the first outer circumferential surface, and
the fourth engagement portion has a stator recess indented radially inward from the first outer circumferential surface.

10. An electric work machine corresponding to a first type of work machine in a work machine group including the first type of work machine and a second type of work machine,
the first type of work machine comprising:
a first brushless motor including first coils and a first stator, the first coils being wound in parallel connection, the first stator having an inner shape and a first outer shape, the inner shape having teeth and a specified inner diameter, each of the teeth having a specified shape;
a controller configured to excite the first stator; and
a first housing configured to house the first brushless motor,
the second type of work machine comprising:
a second brushless motor including second coils and a second stator, the second coils being wound in series connection, the second stator having the inner shape common to that of the first stator and a second outer shape different from the first outer shape; and
a second housing configured to house the second brushless motor.

11. The electric work machine according to claim 10, wherein
the second stator has a second outer shape different from the first outer shape.

12. The electric work machine according to claim 11, wherein
the first stator is fixed to the first housing in a direction of a rotational axis of the first brushless motor by a screw, and
the second stator is fixed to the second housing in a direction of a rotational axis of the second brushless motor by the second housing without a screw.

13. The electric work machine according to claim 12, wherein
the first housing includes an integral cylinder, and
the second housing includes a pair of split halves.

14. An electric work machine set, comprising:
the first type of work machine and the second type of work machine according to claim 1.

15. An electric work machine, comprising:
a first brushless motor including first coils and a first stator, the first stator having an inner shape and an outer shape, the inner shape having teeth and a specified inner diameter, each of the teeth having a specified shape, the inner shape being identical to an inner shape of a second stator of a second brushless motor included in another electric work machine, the outer shape differing from an outer shape of the second stator;
a controller configured to excite the first stator; and
a first housing configured to house the first brushless motor.
